(19) United States
(12) Patent Application Publication
(10) Pub. No.: US 2020/0349043 A1
(43) Pub. Date: Nov. 5, 2020

(54) Software Installation System, Software Installation Method, and Software Installation Program

(71) Applicant: Hitachi, Ltd., Chiyoda-ku, Tokyo (JP)

(72) Inventor: Kazumasa SUGIMOTO, Tokyo (JP)

(73) Assignee: Hitachi, Ltd., Chiyoda-ku, Tokyo (JP)

(21) Appl. No.: 16/642,631

(22) PCT Filed: Aug. 31, 2018
(86) PCT No.: PCT/JP2018/032340

§ 371 Date: Feb. 27, 2020

(30) Foreign Application Priority Data
Sep. 1, 2017 (JP) 2017-168219

(51) Int. Cl. G06F 11/30; G06F 11/07; G06F 9/445; G06F 8/61

(52) U.S. Cl. CPC G06F 11/302; G06F 8/61; G06F 9/44505; G06F 11/0772

(57) ABSTRACT

A software installation system including a processor and a memory for installing software having a predetermined configuration on an information processing device, the software installation system includes: an installability information storage unit that stores information on the software that has failed to be installed on the information processing device, and information on a cause of the failure; and a software installation unit that determines, when a designated software fails to be installed, whether the designated software is capable of being installed based on the stored information on the cause of the failure, and when the designated software is determined to be capable of being installed, executes a predetermined process associated with the cause to install the designated software on the information processing device.

### TECHNICAL FIELD

The present invention relates to a software installation system, a software installation method, and a software installation program.

### BACKGROUND ART

### Incorporation by Reference

This application claims priority to Japanese Patent Application No. 2017-168219 filed on Sep. 1, 2017, the entire disclosure of which is incorporated herein by reference.

With the development of the so-called IoT (Internet of Things) technology, a large number of server devices and the like have been connected on a network. In addition, there are increasing opportunities for handling large amounts of data available on such a network. In such an environment, the work of installing software (installation work) on each server device is generally complicated and requires a lot of time. In particular, for software made of a plurality of component programs for handling a large amount of data, it is necessary to properly combine the components and also correctly construct an operating environment for the created software (e.g., creating and modifying a software setting file or a network setting file). Accordingly, various techniques for automatically performing such a work have been proposed. For example, Patent Literature 1 discloses that, in the installation of application software using a VM (Virtual Machine), setting target items in a setting file or a setting script for an application software are automatically replaced to automatically construct an operating environment of the application software.

### CITASTION LIST

### Patent Literature

[Patent Literature 1] JP-A-2011-60035

### SUMMARY OF INVENTION

### Technical Problem

The technology described in Patent Literature 1 rewrites values available in an application deployment system based on a setting file and a setting script which are templates prepared by a user in advance, to automatically construct the operating environment of the application software. However, there is no process in the case of any errors or the like occurring in the rewriting process. Therefore, every time an error or the like occurs, the user has to find the cause of the error and deal with it. For this reason, such an automatic construction of an operating environment in installing software has been insufficient.

The present invention has been made in view of such circumstances, and one object of the present invention is to provide a software installation system, a software installation method, and a software installation program that enable smooth installation of software.

### Solution to Problem

An aspect of the invention to solve the above objective is a software installation system comprising a processor and a memory for installing software having a predetermined configuration on an information processing device, the software installation system comprising: an installability information storage unit that stores information on the software that has failed to be installed on the information processing device, and information on a cause of the failure; and a software installation unit that determines, when a designated software fails to be installed, whether the designated software is capable of being installed based on the stored information on the cause of the failure, and when the designated software is determined to be capable of being installed, executes a predetermined process associated with the cause to install the designated software on the information processing device.

### Advantageous Effects of Invention

According to the present invention, it is possible to provide smooth installation of software.

### BRIEF DESCRIPTION OF DRAWINGS

FIG. 1 is a diagram illustrating an example of a configuration of a software installation system 100 according to the present embodiment.

FIG. 2 illustrates an example of a hardware configuration of each information processing device (a user terminal 101, a Web server 103, a data storage server 104, a construction execution server 105, and a construction target server 106) in the software installation system 100.

FIG. 3 is a diagram illustrating an example of functions of the user terminal 101 and the Web server 103.

FIG. 4 is a diagram illustrating an example of a function of the data storage server 104.

FIG. 5 illustrates an example of unavailable-combination information 301.

FIG. 6 illustrates an example of construction process re-executability information 302.

FIG. 7 is a diagram illustrating an example of a function of the construction execution server 105.

FIG. 8 is a diagram illustrating an example of a function of the construction target server 106.

FIG. 9 illustrates an example of an operation sequence of a software installation process.

FIG. 10 illustrates an example of a selected component screen.

FIG. 11 illustrates an example of a construction status display screen.

FIG. 12 illustrates an example of a construction completion display screen.

FIG. 13 is a flowchart illustrating an example of processing performed by the Web server 103 in the software installation process.

FIG. 14 illustrates an example of a selected component combination error display screen displayed on the user terminal 101.

FIG. 15 illustrates an example of a construction process error display screen displayed on the user terminal 101.

FIG. 16 is a flowchart illustrating an example of processing performed by the construction execution server 105 in the software installation process.

FIG. 17 is a flowchart illustrating an example of a construction material creation process.

FIG. 18 is a flowchart illustrating an example of a construction execution process.

FIG. 19 is a flowchart illustrating an example of a construction process of processes performed by the construction target server 106 in the software installation process.

FIG. 20 is a flowchart illustrating an example of an initialization process of the processes performed by the construction target server 106 in the software installation process.

### DESCRIPTION OF EMBODIMENT(S)

An embodiment of the present invention will be described below in detail with reference to the drawings.

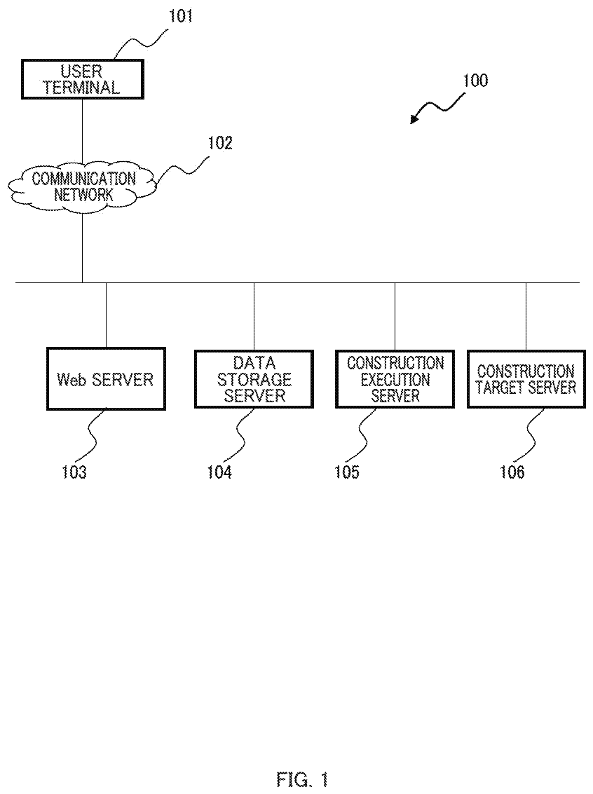

FIG. 1 is a diagram illustrating an example of a configuration of a software installation system 100 according to the present embodiment. The software installation system 100 includes a user terminal 101, a Web server 103 that receives and outputs data from and to the user terminal 101, a data storage server 104 that stores data necessary to construct an operating environment of software to be installed, a construction execution server 105 that constructs the operating environment, and one or more construction target servers 106 on which the operating environment constructed by the construction execution server 105 is installed together with the software. The user terminal 101, the Web server 103, the data storage server 104, the construction execution server 105, and the construction target server 106 are communicably connected to one another via a network 102 that is composed of, for example, a LAN (Local Area Network), a WAN (Wide Area Network), the Internet, a dedicated line, and the like.

The software installation system 100 is an information processing system for installing, on the construction target server 106, software (hereinafter, referred to as installed software) created by combining a plurality of component programs (e.g., applications, middleware, software, or other unit information, and hereinafter, referred to as components). It is to be noted that the installed software is, for example, software for analyzing a large amount of data.

The software installation system 100 installs an installed software having such a predetermined configuration on the construction target server 106, and also constructs, in the construction target server 106, setting information (hereinafter, referred to as operating environment information) for causing the installed software to normally operate on the construction target server 106. The operating environment information is, for example, a setting file for setting the installed software or each component, a setting file for the network 102, and the like.

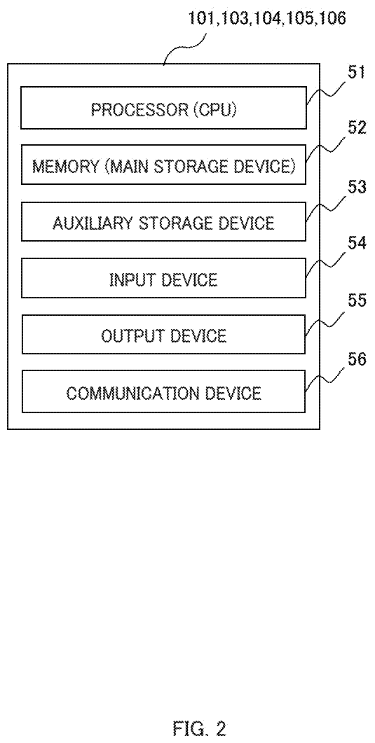

Here, FIG. 2 illustrates an example of a hardware configuration of each information processing device (the user terminal 101, the Web server 103, the data storage server 104, the construction execution server 105, and the construction target server 106) in the software installation system 100. As illustrated in FIG. 2, each information processing device includes a processor 51 such as a CPU (Central Processing Unit), a memory 52 such as a RAM (Random Access Memory) and a ROM (Read Only Memory), an auxiliary storage device 53 such as an HDD (Hard Disk Drive) and an SSD (Solid State Drive), an input device 54 including a keyboard, a mouse, a touch panel, and the like, an output device 55 including a monitor (display), and the like, and a communication device 56 that communicates with another information processing device.

<Functions>

Next, functions of each information processing device will be described.

<<User Terminal 101 and Web Server 103>>

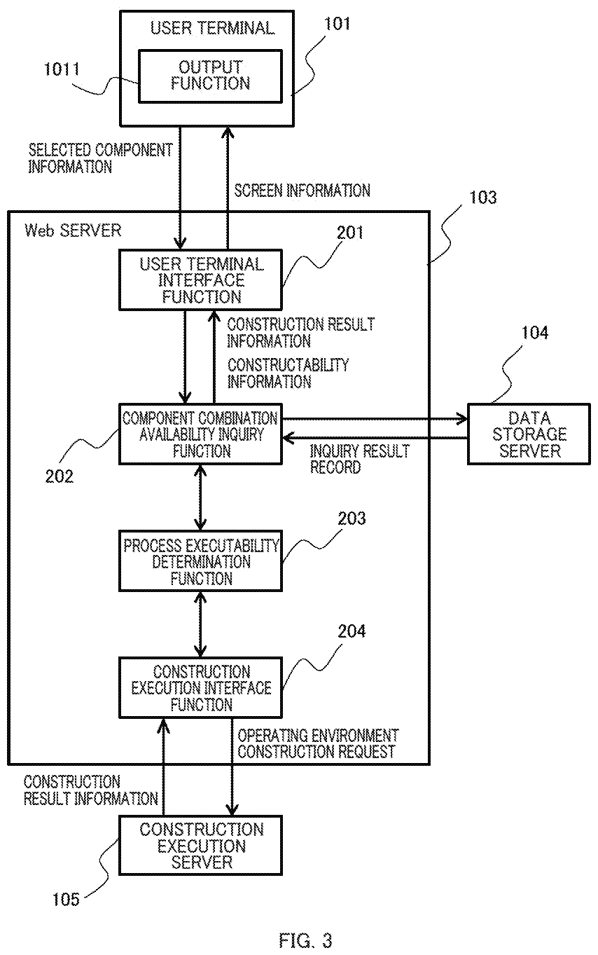

FIG. 3 is a diagram illustrating an example of functions of the user terminal 101 and the Web server 103.

The user terminal 101 receives a designation of software to be installed (installed software) from the user. Specifically, the user terminal 101 has a function of receiving a designation of components constituting the installed software.

Further, the user terminal 101 includes an output function 1011 that outputs information indicating a result of determination as to whether or not the designated software (installed software) is capable of being installed.

Next, the Web server 103 has a user terminal interface function 201, a component combination availability inquiry function 202, a process executability determination function 203, and a construction execution interface function 204.

The user terminal interface function 201 communicates with the user terminal 101 via the network 102. Specifically, the user terminal interface function 201 receives the installed software designated by the user terminal 101, specifically, information on components constituting the installed software (hereinafter, referred to as selected component information).

Further, the user terminal interface function 201 includes information indicating a processing result and transmitted from the process executability determination function 203 (hereinafter, referred to as constructability information), and information indicating a processing result and transmitted from the construction execution interface function 204 (hereinafter, referred to as construction result information). The user terminal interface function 201 creates predetermined screen information corresponding to the received information, and transmits the created screen information to the user terminal 101. Then, the user terminal 101 displays the information indicated by the received screen information on the output device 55.

The component combination availability inquiry function 202 communicates with the data storage server 104 via the network 102. Specifically, for example, the component combination availability inquiry function 202 transmits a predetermined inquiry command to the data storage server 104 to determine whether or not the operating environment information can be constructed based on the selected component information acquired by the user terminal interface function 201. Then, the component combination availability inquiry function 202 receives, from the data storage server 104, information indicating whether the operating environment information can be constructed (hereinafter, referred to as an inquiry result record).

The process executability determination function 203 determines whether or not the operating environment information can be constructed based on the inquiry result record received by the component combination availability inquiry function 202. Specifically, for example, if the inquiry result record is information indicating that the operating environment information can be constructed, the process executability determination function 203 calls the construction execution interface function 204. On the other hand, if the inquiry result record is information indicating that the operating environment information cannot be constructed, the process executability determination function 203 transmits constructability information indicating an error to the user terminal interface function 201.

The construction execution interface function 204 communicates with the construction execution server 105 via the network 102. Specifically, for example, when the process executability determination function 203 is called, the construction execution interface function 204 transmits, to the construction execution server 105, information indicating a request to construct the operating environment information accompanied by the selected component information received by the user terminal interface function 201 (hereinafter, referred to as an operating environment construction request). Thereafter, the process executability determination function 203 receives information indicating a processing result (construction result information) transmitted from the construction execution server 105, and transmits the received construction result information to the user terminal interface function 201.

<<Data Storage S4erver 104>>

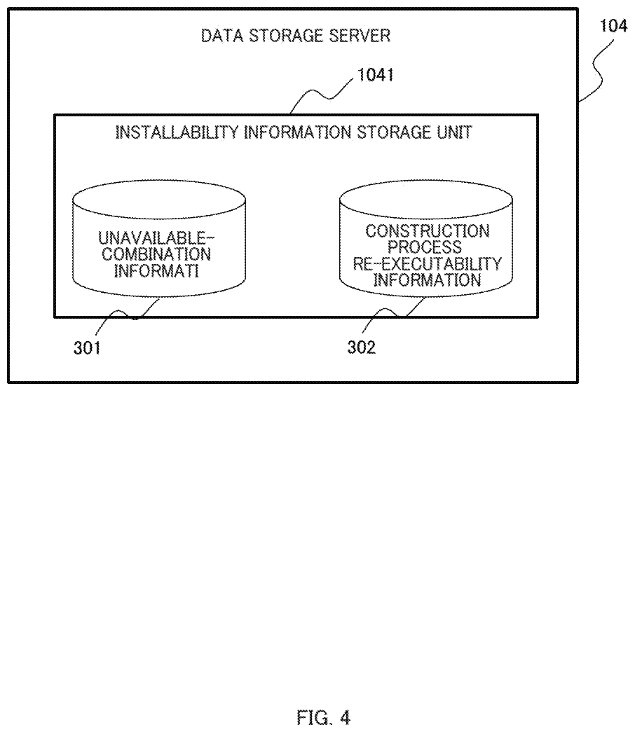

FIG. 4 is a diagram illustrating an example of a function of the data storage server 104. As illustrated in FIG. 4, the data storage server 104 includes an installability information storage unit 1041.

That is, the installability information storage unit 1041 stores information on the software that has failed to be installed on the information processing device (the construction target server 106), and information on the cause of the failure.

Specifically, the installability information storage unit 1041 stores, as the information on the cause of the failure, information on the configuration of the software that has failed in the installation (e.g., information on components constituting the software in which an error occurred during the installation), in unavailable-combination information 301 and construction process re-executability information 302. The installability information storage unit 1041 also stores, as the information on the cause of the failure, information on a process that was being executed when the software failed to be installed (e.g., information on what process the error occurred in), in the construction process re-executability information 302.

<Unavailable-Combination Information>

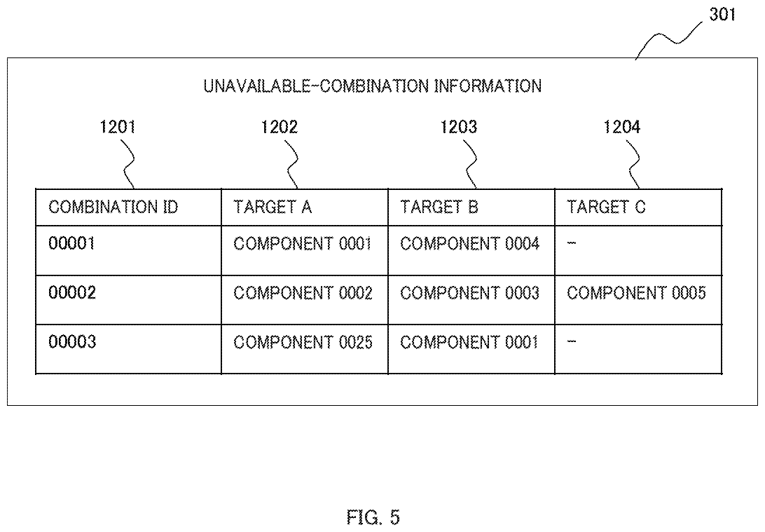

FIG. 5 illustrates an example of the unavailable-combination information 301. The unavailable-combination information 301 is a database that has, as record items, a combination ID 1201 in which identifiers each for identifying a combination of components constituting an installed software (hereinafter, referred to as combination IDs) are stored, a target A 1202, a target B 1203, and a target C 1204 in which component identifiers (hereinafter, referred to as component IDs) are registered. It is to be noted that, in the combination ID 1201, values that are each unique in the order of registering the corresponding record are registered, and the values themselves have no meaning. Further, in the example illustrated in FIG. 5, the number of items in which the component IDs are stored is three (the target A 1202, the target B 1203, and the target C 1204), but may be four or more, or two or less.

The unavailable-combination information 301 is input in advance by, for example, a user or an administrator of the software installation system 100 (hereinafter, referred to as a user).

<Construction Process Re-Executability Information>

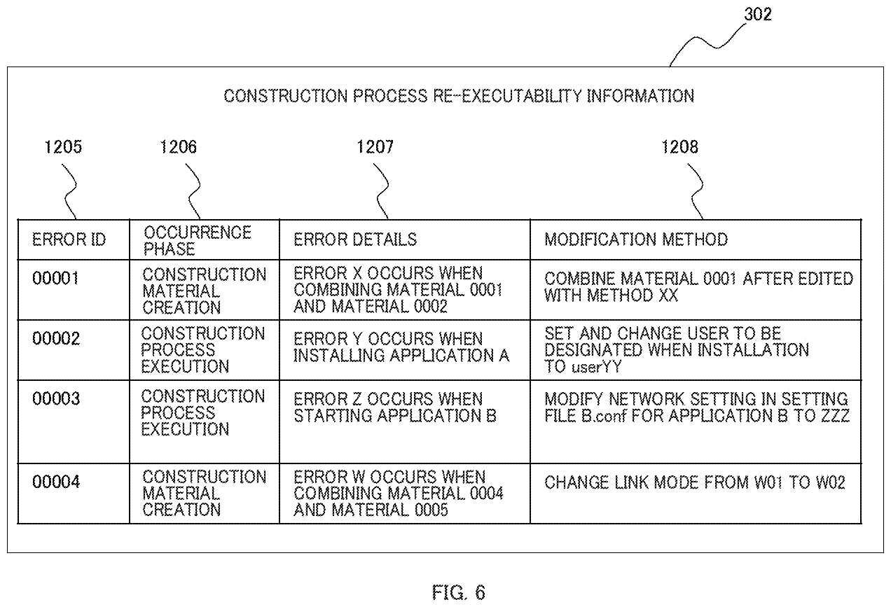

FIG. 6 is a diagram illustrating an example of the construction process re-executability information 302. The construction process re-executability information 302 is a database that has at least one record having, as record items, items of: an error ID 1205 in which identifiers for identifying records (hereinafter referred to as error IDs) are stored, an occurrence phase 1206 in which pieces of information each for identifying a construction material creation process and a construction execution process (both described later) (hereinafter, referred to as phase IDs) are stored, error details 1207 in which pieces of information each indicating details of an error occurring in the process indicated by the occurrence phase 1206 are stored (hereinafter, referred to as error information), and a modification method 1208 in which pieces of information each relating to a process to be executed when the construction material creation process or the construction execution process (hereinafter, referred to as a “modification process”) is re-executed (hereinafter, referred to as “modification information”) are stored.

If information indicating the construction material creation process is stored in the occurrence phase 1206, for example, information on a combination of components that caused an error during the installation of the installed software (e.g., a link between components) is stored as error information in the error details 1207. On the other hand, if information indicating the construction execution process is stored in the occurrence phase 1206, for example, information on a process that was being executed when an error relating to the installation of the installed software occurred (e.g., an installation process for a case where an error occurred during the installation, or a process for starting the installed software for a case where an error occurred when the installed software was started) is stored as error information in the error details 1207.

If information indicating the construction material creation process is stored in the occurrence phase 1206, for example, information relating to a method of linking components and the timing of linking (e.g., a process of changing the order of editing and linking the components, or a process of changing the link mode of components) is stored in the modification method 1208. On the other hand, if information indicating the construction execution process is stored in the occurrence phase 1206, for example, information for creating or modifying setting information of the installed software (e.g., user setting information for the installation, network setting information, or a setting file) is stored in the modification method 1208.

It is to be noted that the value itself in the error ID 1205 has no meaning. Further, in FIG. 6, in the error details 1207, a natural language text is stored, but information in other formats including a plurality of pieces of information, for example, selected component information, information on an internal process, and information for executing an exception process, may be stored. Further, also in the modification method 1208, a natural language text is stored, but information in other formats, for example, information of a plurality of commands for a computer to identify a modification target and modification details may be stored.

Next, the function of the construction execution server 105 will be described.

<<Construction Execution Server 105>>

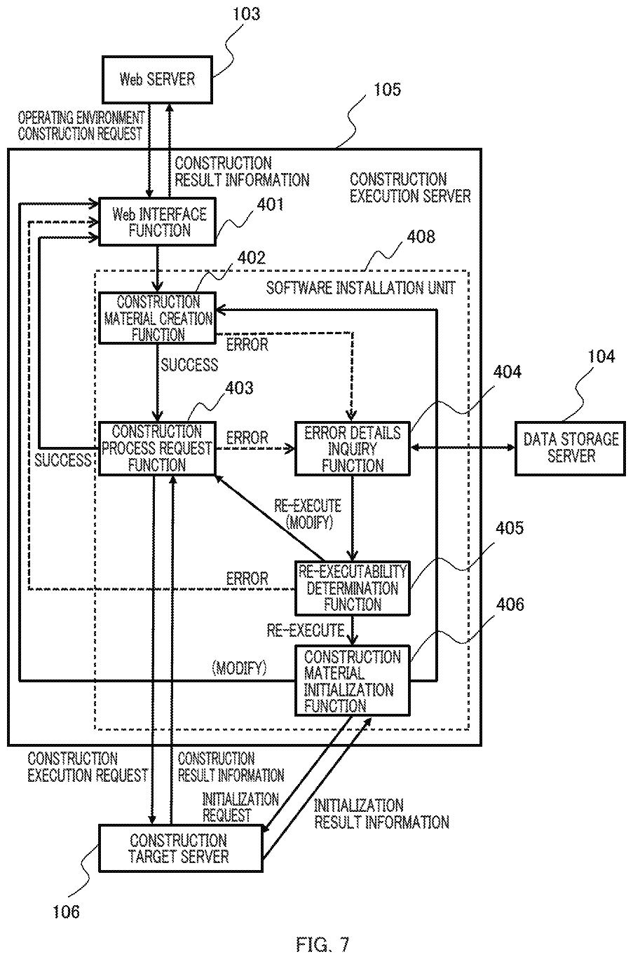

FIG. 7 is a diagram illustrating an example of a function of the construction execution server 105. The construction execution server 105 includes a Web interface function 401 and a software installation unit 408. The software installation unit 408 has a construction material creation function 402, a construction process request function 403, an error details inquiry function 404, a re-executability determination function 405, and a construction material initialization function 406.

The Web interface function 401 communicates with the Web server 103 via the network 102. Specifically, for example, when the Web interface function 401 receives an operating environment construction request from the Web server 103, the Web interface function 401 calls the construction material creation function 402 of the software installation unit 408. Further, the Web interface function 401 transmits information on a processing result (construction result information) received from the construction process request function 403 of the software installation unit 408 to the Web server 103.

When the installability information storage unit 1041 fails to install the designated software, the software installation unit 408 determines whether or not the designated software (installed software designated by the user terminal 101) is capable of being installed based on the stored information on the cause of the failure (in the data storage server 104, the unavailable-combination information 301 or the construction process re-executability information 302). If the software installation unit 408 determines that the designated software is capable of being installed, the software installation unit 408 executes a predetermined process (modification process) associated with the cause to install the designated software on the information processing device (construction target server 106).

Specifically, for example, when the installability information storage unit 1041 fails to install the designated software, the software installation unit 408 determines whether or not the designated software is capable of being installed based on the stored information relating to the configuration of the software (the construction process re-executability information 302 in the data storage server 104). If the software installation unit 408 determines that the designated software is capable of being installed, the software installation unit 408 executes, as the predetermined process (modification process), a process of modifying the configuration of the designated software to install the designated software on the information processing device.

Further, for example, when the installability information storage unit 1041 fails to install the designated software, the software installation unit 408 determines whether or not the designated software is capable of being installed based on the stored information relating to the process (the construction process re-executability information 302 in the data storage server 104). If the software installation unit 408 determines that the designated software is capable of being installed, the software installation unit 408 executes, as the predetermined process (modification process), a process of creating predetermined setting information corresponding to the executing process to install the designated software on the information processing device.

Further, for example, when executing the predetermined process to install the designated software on the information processing device, the software installation unit 408 deletes (initializes) the information created when the designated software failed to be installed.

Hereinafter, each function of the software installation unit 408 will be described in more detail.

The construction material creation function 402 executes a process of combining components so as to be suitable for the installed software (hereinafter, referred to as a construction material creation process) based on the selected component information accompanying the operating environment construction request. It is to be noted that, if the modification information has been created, the construction material creation function 402 also executes the process indicated by the modification information. When successfully creating components suitable for the installed software (hereinafter, referred to as construction materials) by the construction material creation process, the construction material creation function 402 calls the construction process request function 403. When not successfully creating them, the construction material creation function 402 calls the error details inquiry function 404.

The construction process request function 403 communicates with the construction target server 106 via the network 102. Specifically, for example, when called by the construction material creation function 402, the construction process request function 403 installs the installed software accompanying the construction materials on the construction target server 106, and also transmits a request to execute construction of operating environment information for the installed software (hereinafter, referred to as a construction execution request). Thereafter, the construction process request function 403 receives information indicating a processing result (construction result information) from the construction target server 106. If the construction result information is information indicating success, the construction process request function 403 transmits the construction result information indicating success to the Web interface function 401. On the other hand, if the construction result information is information indicating an error, the construction process request function 403 calls the error details inquiry function 404.

The error details inquiry function 404 communicates with the data storage server 104 via the network 102. Specifically, for example, when called by the construction material creation function 402 or the construction process request function 403, the error details inquiry function 404 transmits predetermined request information to the data storage server 104 and receives, from the data storage server 104, information relating to a combination of components of the installed software for which the construction of the operating environment information has failed in the past (hereinafter, referred to as an error information record).

The re-executability determination function 405 determines whether or not to re-execute the construction of the operating environment information based on the error information record received by the error details inquiry function 404.

In the case where the re-executability determination function 405 is called by the construction material creation function 402, if the re-executability determination function 405 determines that the construction of the operating environment information is not to be re-executed, the re-executability determination function 405 transmits configuration result information indicating an error to the Web interface function 401. On the other hand, if the re-executability determination function 405 determines that the construction of the operating environment information is to be re-executed, the re-executability determination function 405 creates modification information based on the error information record, and also calls the construction material initialization function 406.

Meanwhile, in the case where the re-executability determination function 405 is called by the construction process request function 403, if the re-executability determination function 405 determines that the construction of the operating environment information is not to be re-executed, the re-executability determination function 405 transmits configuration result information indicating an error to the Web interface function 401. On the other hand, if the re-executability determination function 405 determines that the construction of the operating environment information is to be re-executed, the re-executability determination function 405 creates modification information based on the error information record, and also calls the construction process request function 403.

The construction material initialization function 406 communicates with the construction target server 106 via the network 102, and deletes the construction materials previously created by the construction material creation function 402 in order to re-execute the construction material creation function 402. In other words, the construction material initialization function 406 transmits an initialization request to the construction target server 106. It is to be noted that, thereafter, the construction material initialization function 406 receives information indicating a result of the initialization (hereinafter, referred to as initialization result information). Thereafter, the construction material creation function 402 is performed.

<<Construction Target Server 106>>

Next, a function of the construction target server 106 will be described.

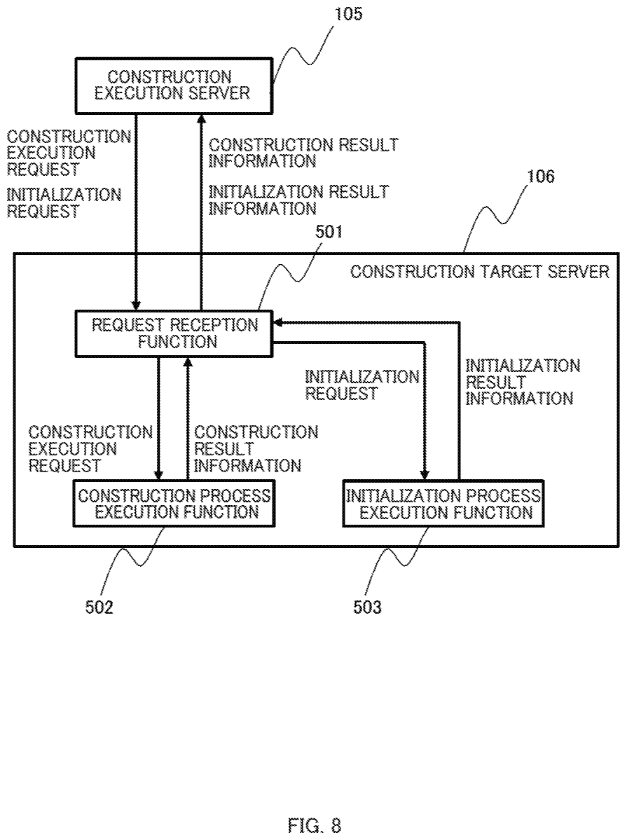

FIG. 8 is a diagram illustrating an example of the function of the construction target server 106. The construction target server 106 has a request reception function 501, a construction process execution function 502, and an initialization process execution function 503.

The request reception function 501 communicates with the construction execution server 105 via the network 102. Specifically, for example, when receiving a construction execution request from the construction execution server 105, the request reception function 501 calls the construction process execution function 502. It is to be noted that, thereafter, the request reception function 501 transmits information received from the construction process execution function 502 and indicating a processing result (construction result information) to the construction execution server 105.

Similarly, when receiving the initialization request from the construction execution server 105, the request reception function 501 calls the initialization process execution function 503. Thereafter, the request reception function 501 receives information received from the initialization process execution function 503 and indicating a processing result (initialization result information) to the construction execution server 105.

When called by the request reception function 501, the construction process execution function 502 installs the installed software on the construction target server 106 based on the construction execution request accompanying the construction materials, also constructs the operating environment information for the installed software, and then transmits construction result information storing their results to the request reception function 501.

When called by the request reception function 501, the initialization process execution function 503 initializes (deletes) the construction materials (components) previously created by the construction process execution function 502 based on the initialization request, and transmits initialization result information storing the processing result to the request reception function 501. As a result, the construction process execution function 502 becomes ready to be executed again.

The functions of each of the information processing devices described above are implemented by hardware of the corresponding information processing device, or by the processor 51 of the information processing device reading out and executing each program stored in the memory 52 or the auxiliary storage device 53. It is to be noted that such a program is stored in, for example, a storage device such as a secondary storage device, a nonvolatile semiconductor memory, a hard disk drive, or an SSD, or a computer-readable non-transitory data storage medium such as an IC card, an SD card, or a DVD.

<Processing Sequence>

Next, processing performed in the software installation system 100 will be described.

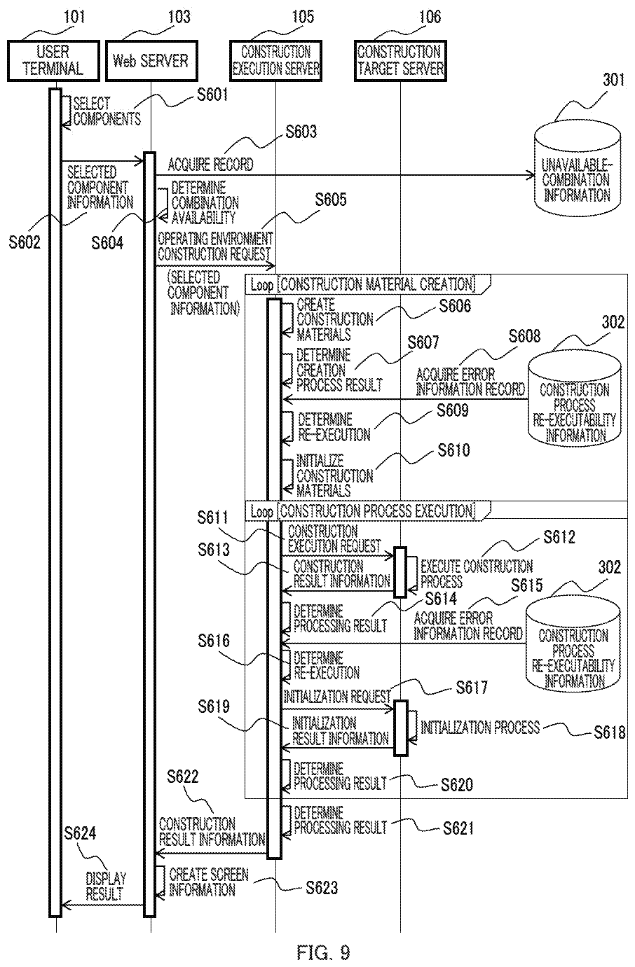

FIG. 9 is a diagram illustrating an example of a processing sequence of a process of installing an installed software on the construction target server 106 (hereinafter, referred to as a software installation process). This process is started, for example, in response to a predetermined input from the user to the user terminal 101.

First, the user terminal 101 receives a selection of components constituting the installed software from the user (S601).

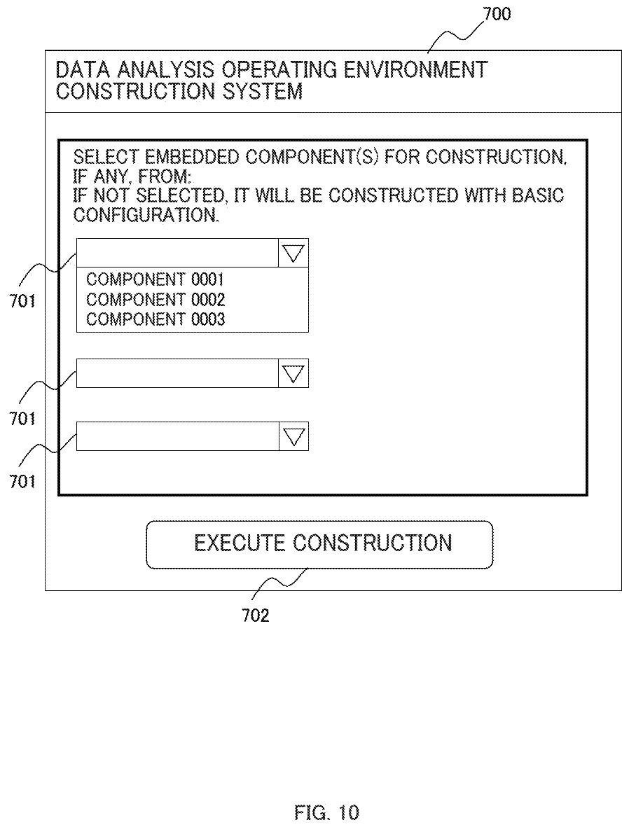

Here, FIG. 10 illustrates an example of a screen displayed on the user terminal 101 in S601 (hereinafter, referred to as a selected component screen). A selected component screen 700 is an input screen for receiving a selection of components from the user, and includes a pull-down 701 for receiving a selection of one or a plurality of components, and an execution button 702 for completing the selection of the component(s) through the pull-down 701.

Next, as illustrated in S602 of FIG. 9, the user terminal 101 transmits a process request accompanying selected component information indicating the components selected in S601 to the Web server 103.

When receiving the process request, the Web server 103 acquires an inquiry result record from the unavailable-combination information 301 (S603). Then, the Web server 103 determines whether or not the operating environment information can be constructed based on the inquiry result record acquired in S603 (S604). If it is determined that the operating environment information can be constructed, the Web server 103 transmits the operating environment construction request accompanying the selected component information to the construction execution server 105 (S605).

When receiving the operating environment construction request from the Web server 103, the construction execution server 105 executes a process of creating the construction materials as follows (S606 to S610). That is, the construction execution server 105 attempts to create the construction materials based on the selected component information accompanied by the operating environment construction request (S606). Then, the construction execution server 105 determines whether or not the construction materials have been successfully created (S607). If it is determined that the construction materials have been successfully created, the construction execution server 105 executes the process of S611 described later. However, if it is determined that the construction materials have not been successfully created, the construction execution server 105 acquires an error information record from the construction process re-executability information 302 (S608). The construction execution server 105 determines whether or not to re-execute the construction of the operating environment information based on the acquired error information record (S609). If it is determined that the construction of the operating environment information is to be re-executed, the construction execution server 105 initializes (deletes) the construction materials previously created (S610), and then re-executes the process of S606.

Next, the construction execution server 105 installs, on the construction target server 106, the installed software based on the construction materials, and also executes a process of executing the construction of the operating environment for the installed software (construction execution process) as follows (S611 to S620). Specifically, first, the construction execution server 105 transmits a construction execution request accompanying the created construction materials to the construction target server 106 (S611). Based on the received construction execution request, the construction target server 106 executes the process of installing the installed software, and also executes a process of constructing the operating environment information for the installed software (hereinafter, referred to as a construction process) (S612). Then, the construction execution server 105 receives construction result information from the construction target server 106 (S613).

The construction execution server 105 determines, based on the received construction result information, whether or not the installed software and its operating environment information have been successfully constructed in the construction target server 106 (S614). If it is determined that the operating environment information has been successfully constructed, the construction execution server 105 executes the process of S621 described later. On the other hand, if it is determined that the operating environment information has not been successfully constructed, the construction execution server 105 acquires error information record from the construction process re-executability information 302 (S615), and determines whether or not to re-execute the construction of the operating environment information for the installed software based on the acquired error information record (S616).

If the construction execution server 105 determines that the construction of the operating environment information is to be re-executed, the construction execution server 105 transmits an initialization request to the construction target server 106 (S617). Based on the received initialization request, the construction target server 106 executes a process of initializing (deleting) the operating environment information that has failed to be constructed in S612 and information relating thereto (S618) (hereinafter, referred to as an initialization process), and transmits initialization result information indicating a result of the initialization process to the construction execution server 105. When receiving the initialization result information (S619), the construction execution server 105 determines whether or not the operating environment information has been initialized based on the received initialization result information (S620). If it is determined that the operating environment information has been initialized, the construction execution server 105 executes the process of 5611 again. On the other hand, if it is determined that the operating environment information has not been initialized, the construction execution server 105 executes a predetermined process to end the software installation process (not illustrated).

In S621, the construction target server 106 stores details of the process executed in the construction execution process, and transmits the details to the Web server 103 as construction result information (S621, S622).

The Web server 103 creates screen information on a screen to be displayed on the user terminal 101 based on the construction result information received from the construction target server 106 (S623). The Web server 103 transmits the created screen information to the user terminal 101, and the user terminal 101 displays information indicated by the received screen information on the screen (S624). Thus, the software installation process ends.

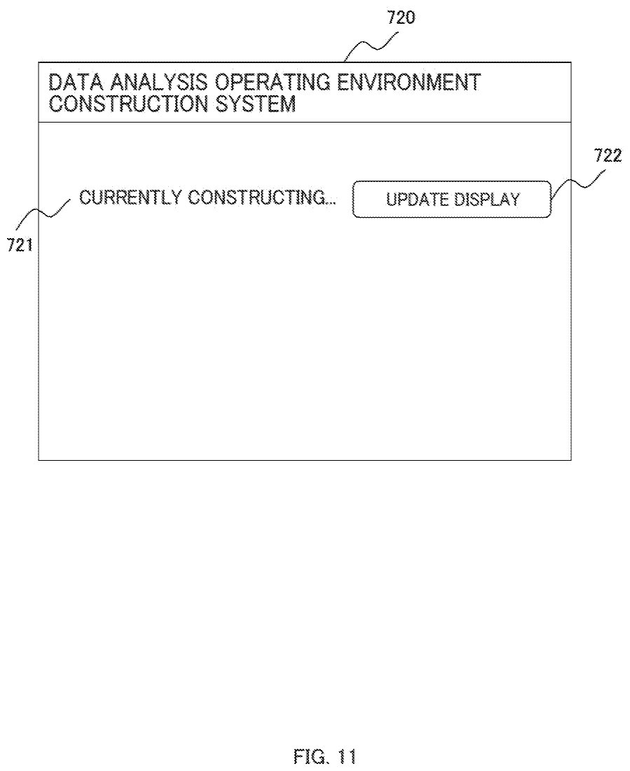

Here, FIG. 11 illustrates an example of a screen displayed on the user terminal 101 while the Web server 103 is executing the construction material creation process or the construction process execution process (hereinafter, referred to as a construction status display screen). A construction status display screen 720 includes a progress description field 721 in which details of the process being performed by the Web server 103 is displayed, and an update button 722 for updating the details displayed in the progress description field 721. The user can confirm the progress status of the current process by referring to the construction status display screen 720.

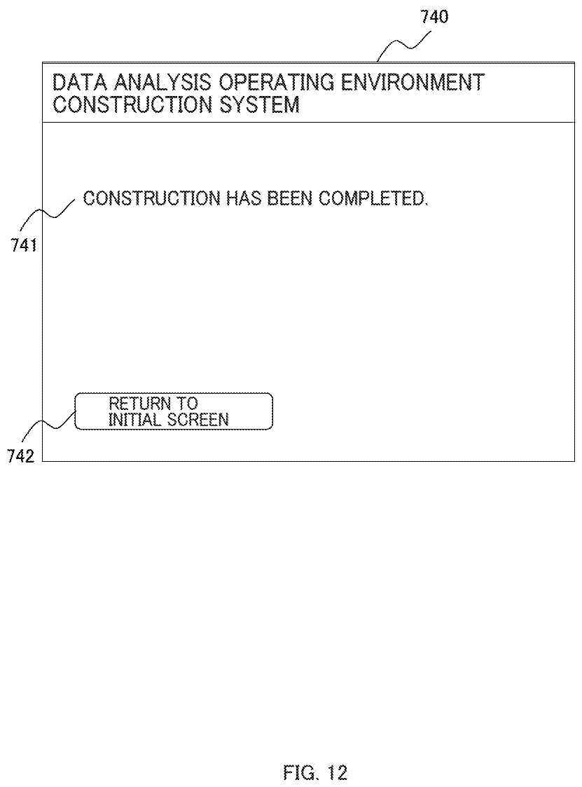

FIG. 12 illustrates an example of a screen displayed on the user terminal 101 after the web server 103 completes the construction material creation process and the construction process execution process (hereinafter, referred to as a construction completion display screen). A construction completion display screen 740 is a screen displayed after the construction status display screen 720, and includes a completion description field 741 in which information indicating that the Web server 103 has completed the construction material creation process and the construction process execution process is displayed, and an initial screen transition button 742 for displaying the selected component screen 700 to allow the user to select components again (e.g., returning to the process of S601 in FIG. 9). By referring to the construction completion display screen 740, the user can confirm that the construction of the operating environment has been completed, and accordingly, the installed software including different components is capable of being re-installed.

<Description of Each Information Processing Device>

Next, details of the processing performed by each information processing device in the software installation process will be described.

<<Processing in Web Server 103>>

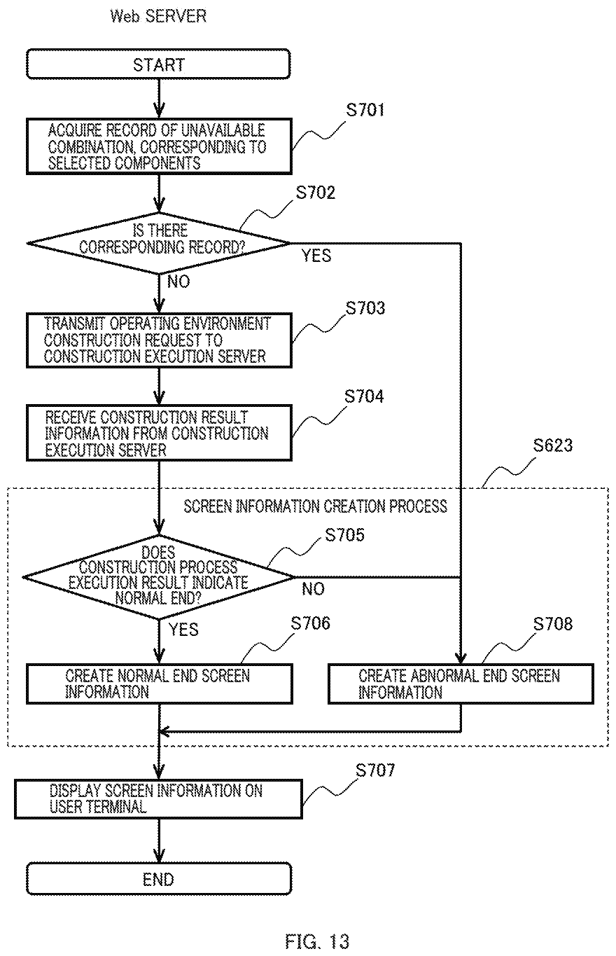

FIG. 13 is a flowchart illustrating an example of processing performed by the Web server 103 in the software installation process. First, the component combination availability inquiry function 202 of the Web server 103 attempts to acquire, from the unavailable-combination information 301, a combination of components corresponding to the selected component information received from the user terminal 101 (S701, corresponding to S603 in FIG. 9).

Specifically, for example, the component combination availability inquiry function 202 identifies, from the unavailable-combination information 301, a record in which a combination of all the components indicated by the selected component information is stored in any of the items from the target A 1202 to the target C 1204, and acquires details of the identified record. For example, if “component 0001” and “component 0002” are selected as the selected component information, in the example illustrated in FIG. 5, the component combination availability inquiry function 202 acquires a record in which “component 0001” and “component 0002” are stored in the unavailable-combination information 301.

When the component combination availability inquiry function 202 can acquire a combination of components (S702: YES), S708 described later is executed. On the other hand, when the component combination availability inquiry function 204 cannot acquire a combination of components (S702: NO), S703 described later is executed.

In this way, the component combination availability inquiry function 202 refers to the unavailable-combination information 301 that stores the components whose combination has been determined to be unavailable, so that the subsequent construction material creation process and the construction execution process can be normally executed.

In S703, the user terminal interface function 201 transmits an operating environment construction request accompanying the selected component information to the construction execution server 105 (corresponding to S605 in FIG. 9). Thereafter, the user terminal interface function 201 receives construction result information corresponding to the operating environment construction request from the construction execution server 105 (S704, corresponding to S622 in FIG. 9).

Next, the user terminal interface function 201 creates a screen for displaying a result of the executed process (S705, S706, S708, corresponding to S623 in FIG. 9). Specifically, the user terminal interface function 201 determines the details of the received construction result information (S705). If the received construction result information includes information indicating normal end (S705: YES), the user terminal interface function 201 creates screen information indicating that the construction execution process has successfully ended (S706), and thereafter, the process of S707 is executed. On the other hand, if the received construction result information includes information indicating abnormal end (S705: NO), the user terminal interface function 201 creates screen information indicating that the construction execution process has abnormally ended (hereinafter, referred to as abnormal end screen information) (S708). Thereafter, the process of S707 is executed.

In S707, the user terminal interface function 201 causes the user terminal 101 to display the screen information created in S706 or S708 (S624 in FIG. 9).

It is to be noted that, for example, when a combination of components can be acquired in S702, the abnormal end screen information is information for displaying an error indicating that the combination of components is not appropriate on the screen (hereinafter, referred to as first abnormal end screen information); when an operating environment cannot be constructed in S705 (S705), the abnormal end screen information is information for displaying an error indicating that the operating environment cannot be constructed on the screen (hereinafter, referred to as second abnormal end screen information).

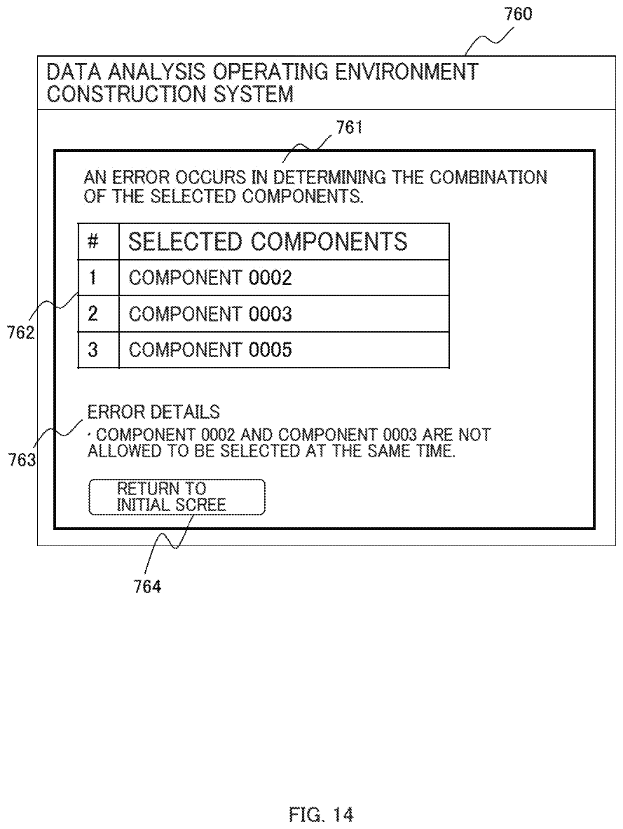

Here, FIG. 14 illustrates an example of a screen displayed on the user terminal 101 based on the first abnormal end screen information (hereinafter, referred to as a selected component combination error display screen). A selected component combination error display screen 760 includes an explanation field 761 in which an overview of an error that has occurred is displayed, a component field 762 in which a list of selected components is displayed, an error details field 763 in which a reason why the combination of the selected components is not appropriate is displayed, and an initial screen transition button 764 for displaying the selected component screen 700 to allow the user to select components again (e.g., return to the process of S601 in FIG. 9). By referring to the selected component combination error display screen 760, the user can confirm that the selected component combination is not appropriate and the reason therefor.

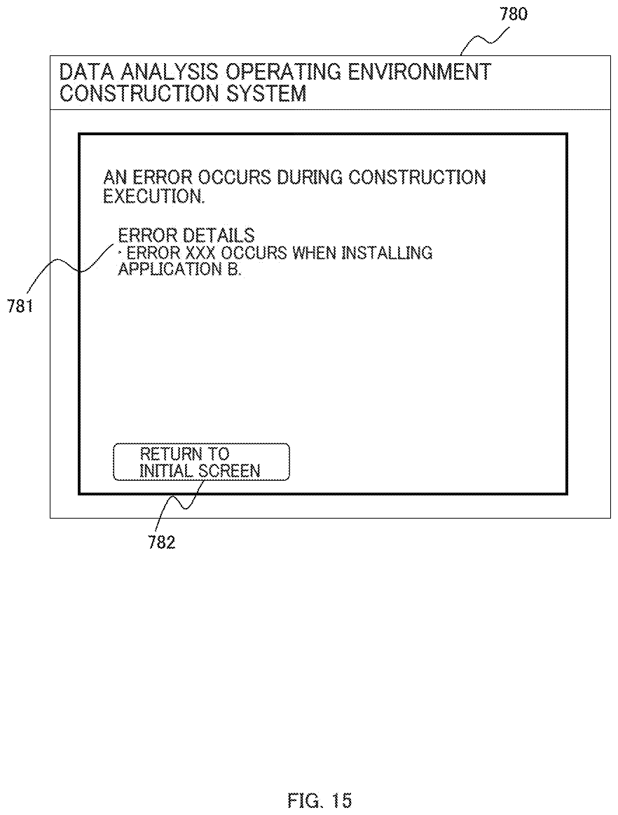

Further, FIG. 15 illustrates an example of a screen displayed on the user terminal 101 based on the second abnormal end screen information (hereinafter, referred to as a construction process error display screen). A construction process error display screen 780 is a screen displayed based on the second abnormal end display information, and includes a description field 781 in which details of an error that has occurred is displayed, and an initial screen transition button 782 for displaying the selected component screen 700 to allow the user to select components again (e.g., return to the process of 5601 in FIG. 9). By referring to the construction process error display screen 780, the user can confirm the details of the error that has occurred during the construction of the operating environment.

<<Processing in Construction Execution Server 105>>

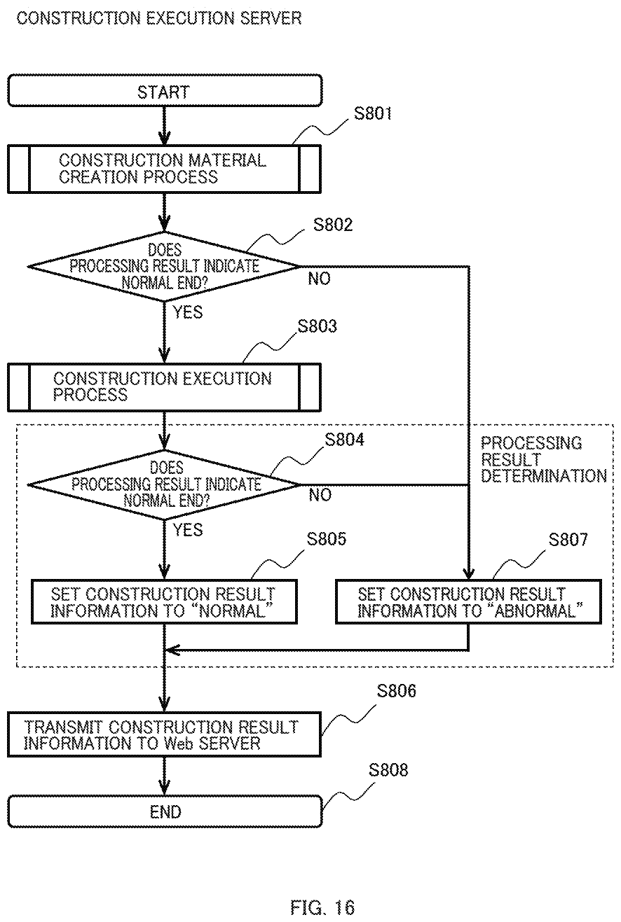

Subsequently, FIG. 16 is a flowchart illustrating an example of processing performed by the construction execution server 105 in the software installation process.

First, the construction material creation function 402 of the construction execution server 105 executes a construction material creation process based on the operating environment construction request (accompanying the selected component information) received from the Web server 104 (S801, corresponding to S606 in FIG. 9). Details of the construction material creation process will be described later.

Next, the construction material creation function 402 determines a result of the construction material creation process executed in S801 (S802, corresponding to S607 in FIG. 9). If the result of the construction material creation process indicates success (S802: YES), the process of S803 described later is executed. If the result of the construction material creation process indicates abnormal (S802: NO), the process of S807 described later is executed.

In S803, the construction process request function 403 executes a construction execution process (corresponding to S611 in FIG. 9). Details of the construction execution process will be described later. Then, the construction process request function 403 determines a result of the executed construction execution process (S804, corresponding to S614 in FIG. 9). If the result of the construction execution process indicates normal end (S804: YES), the Web interface function 401 sets the construction result information to “normal” (S807, corresponding to S621 in FIG. 9), and thereafter, the process of S806 described later is executed. On the other hand, if the result of the construction execution process indicates abnormal end (S804: NO), the Web interface function 401 sets the construction result information to “abnormal” (S805, corresponding to S621 in FIG. 9), and thereafter, the process of S806 is executed.

In S806, the Web interface function 401 transmits the construction result information (normal or abnormal) to the Web server 103 (corresponding to S622 in FIG. 9). Thus, the processing in the construction execution server 105 ends (S808).

Next, the details of the construction material creation process and the construction execution process will be described.

(Construction Material Creation Process)

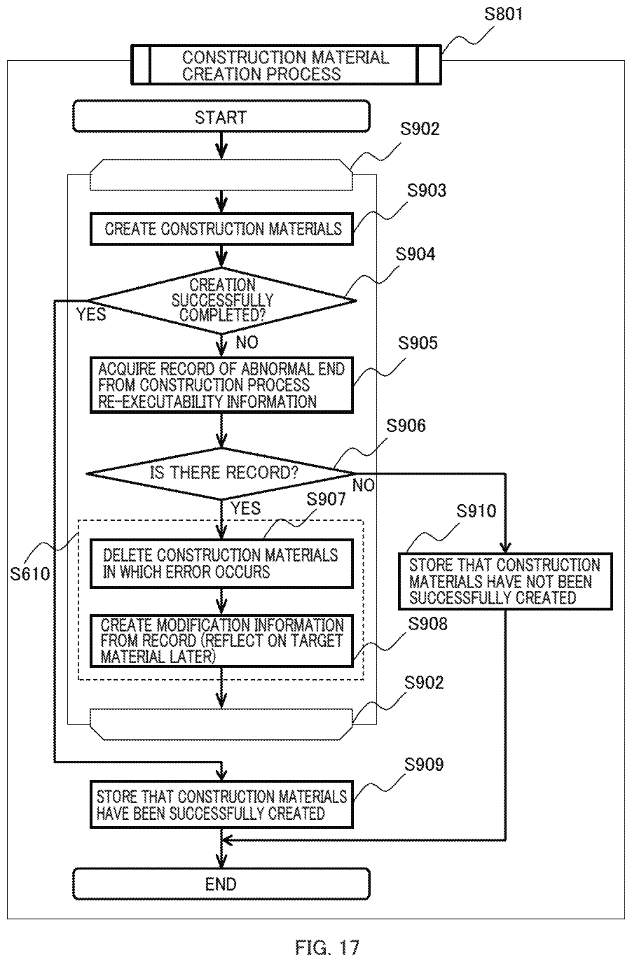

FIG. 17 is a flowchart illustrating an example of the construction material creation process. First, the construction material creation function 402 of the construction execution server 105 attempts to create construction materials based on the selected component information (S903, corresponding to 5606 in FIG. 9). It is to be noted that, if the modification information has been created in S908 described later, the construction material creation function 402 executes the process indicated by the modification information on the created construction materials to reflect the details of the modification information on the construction materials.

Then, the construction material creation function 402 analyzes a result (success or failure) of the creation of the construction materials, and determines whether or not the construction materials have been successfully created (S904). If it is determined that the construction materials have been successfully created (S904: YES), the construction material creation function 402 executes the process of S909 described later. If it is determined that the construction materials have not been successfully created (S904: NO), the construction material creation function 402 executes the process of S905 described later.

In S905, the error details inquiry function 404 attempts to acquire an error information record from the construction process re-executability information 302 (corresponding to S608 in FIG. 9). Specifically, for example, the error details inquiry function 404 extracts all the records in which the occurrence phase 1206 indicates the construction material creation process from the construction process re-executability information 302, and searches the extracted records for a record in which information matching the details analyzed in S903 is stored in the error details 1207.

Then, the re-executability determination function 405 determines a result of the acquisition of the error information record (S906 corresponding to S609 in FIG. 9). If the error information record can be acquired (S906: YES), the re-executability determination function 405 determines that the construction materials are to be created again, and executes the process of S907 described later as an initialization process for that. On the other hand, if the error information record cannot be acquired (S906: NO), the re-executability determination function 405 determines that the construction materials based on the selected component information cannot be created, and executes the process of S910 described later.

In S907, the construction material initialization function 406 deletes the construction materials that has failed to be created in S903 (corresponding to S610 in FIG. 9). The construction material initialization function 406 also analyzes the error information record acquired in S905, and creates modification information (S908, corresponding to S610 in FIG. 9). Specifically, for example, the construction material initialization function 406 analyzes the details of the modification method 1208 in the record retrieved in S905 (record indicating the construction material creation process), and acquires its details. Thereafter, the processing returns to the process of S903 (S902, corresponding to the loop of S606 to S610 in FIG. 9).

In this way, in the construction material creation process, when the construction materials fail to be created, the modification information for dealing with the failure is created based on the construction process re-executability information 302, thereby making it possible to properly create the construction materials.

It is to be noted that, in step S909, the construction material creation function 402 stores (sets) that the construction material creation process has successfully created the construction materials, and accordingly, the construction material creation process ends (corresponding to S607 in FIG. 9).

Further, in step S910, the construction material creation function 402 stores (sets) that the construction material creation process has not successfully created the construction materials, and accordingly, the construction material creation process ends (corresponding to S622 in FIG. 9).

(Construction Execution Process)

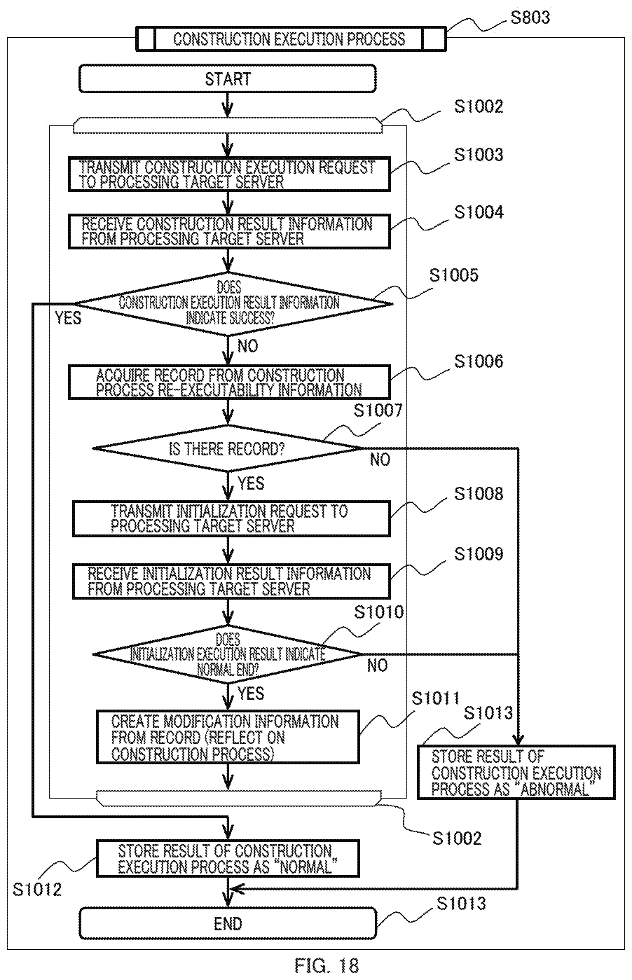

FIG. 18 is a flowchart illustrating an example of the construction execution process. First, the construction process request function 403 of the construction execution server 105 transmits, to the construction target server 106, a construction execution request accompanying information on the construction materials created in the construction material creation process (S1003, corresponding to S611 in FIG. 9). The construction execution request indicates that operating environment information for the installed software based on the created construction materials is to be constructed. Thereafter, the construction process request function 403 receives construction result information transmitted from the construction target server 106 (S1004, corresponding to S613 in FIG. 9), and analyzes the details of the received construction result information (S1005, corresponding to S614 in FIG. 9). If the received construction result information includes information indicating success (S1005: YES), the construction process request function 403 executes the process of S1012 described later. If the received construction result information includes information indicating an error (S1005: NO), the construction process request function 403 executes the process of S1006.

In S1006, the error details inquiry function 404 attempts to acquire an error information record from the construction process re-executability information 302 (corresponding to S615 in FIG. 9). Specifically, for example, the error details inquiry function 404 extracts all the records in which the occurrence phase 1206 indicates the construction execution process from the construction process re-executability information 302, and searches the extracted records for a record in which information matching the details of the construction result information analyzed in S1005 is stored in the error details 1207.

Then, the re-executability determination function 405 determines whether or not an error information record can be acquired in S1006 (S1007, corresponding to S616 in FIG. 9). If the error information record can be acquired (S1007: YES), the re-executability determination function 405 executes the process of S1008. If the error information record cannot be acquired (S1007: NO), the re-executability determination function 405 determines that the operating environment cannot be constructed, and executes the process of S1013.

In S1008, the construction material initialization function 406 determines that the operating environment can be re-constructed, and transmits an initialization request to the construction target server 106 (corresponding to S617 in FIG. 9). Thereafter, the construction material initialization function 406 receives initialization result information from the construction target server 106 (S1009, corresponding to S619 in FIG. 9).

The construction material initialization function 406 determines the received initialization result information (S1010, corresponding to S620 in FIG. 9). If the initialization result information indicates success (S1010: YES), the construction material initialization function 406 executes the process of S1011. If the initialization result information indicates abnormal (S1010: NO), the construction material initialization function 406 executes the process of S1013.

In S1011, the construction material initialization function 406 also analyzes the error information record acquired in S1006, and creates modification information.

Specifically, for example, the construction material initialization function 406 analyzes the details of the modification method 1208 in the record retrieved in S1006 (record indicating the construction execution process), and acquires its details. Then, the construction material initialization function 406 creates a construction execution request accompanying the modification information.

The construction material initialization function 406 transmits the created construction execution request (corresponding to the loop of S1005, S1002, and S611 to S620 in FIG. 9).

In this way, in the construction execution process, when the operating environment information fails to be created, the modification information for a process for dealing with the failure is created based on the construction process re-executability information 302, thereby making it possible to properly construct the operating environment.

It is to be noted that, in step S1012, the web interface function 401 stores that the result of the construction execution process indicates “normal”, and accordingly, the construction execution process ends. Further, in step S1013, the web interface function 401 stores that the result of the construction execution process indicates “abnormal”, and accordingly, the construction execution process ends (S1013, corresponding to S621 to S622 in FIG. 9).

<<Construction Target Server 106>>

Next, processing performed by the construction target server 106 will be described.

(Construction Process)

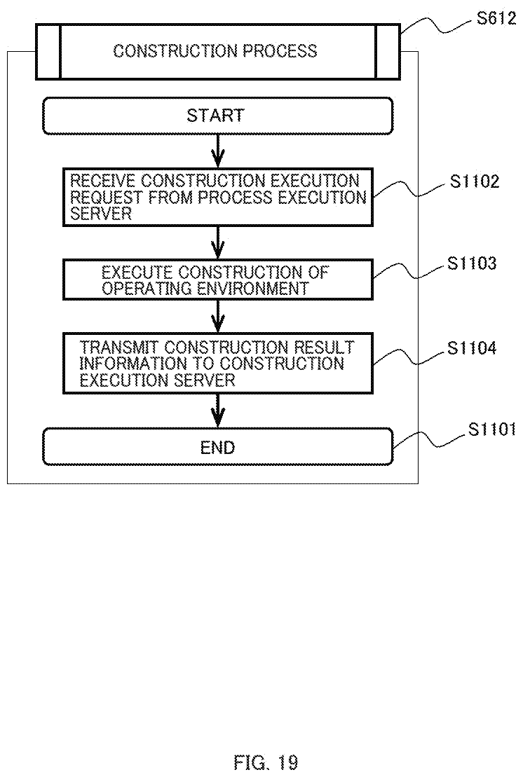

FIG. 19 is a flowchart illustrating an example of a construction process of processes performed by the construction target server 106 in the software installation process. First, when the request reception function 501 of the construction target server 106 receives the construction execution request from the construction execution server 105 (S1102), the construction process execution function 502 executes a process corresponding to the received construction execution request (S1103).

Specifically, for example, the construction process execution function 502 installs the installed software on the construction target server 106 based on the construction materials accompanied by the construction execution request, and also constructs operating environment information corresponding to the installed software. Further, the construction process execution function 502 executes the process indicated by the modification information accompanied by the construction execution request, and modifies the operating environment information.

Thereafter, the request reception function 501 transmits information on the result of the process executed in S1103 (construction result information. e.g., success or error) to the construction execution server 105 (S1104). Accordingly, the construction process ends (S1101).

(Initialization Process)

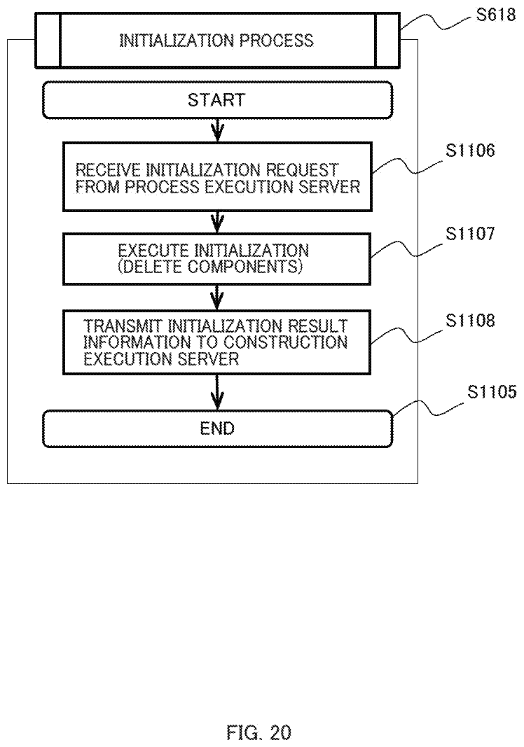

Next, FIG. 20 is a flowchart illustrating an example of an initialization process of the processes performed by the construction target server 106 in the software installation process. First, when the request reception function 501 receives the initialization request from the construction execution server 105 (S1106), the initialization process execution function 503 executes a process corresponding to the received initialization request (S1107). Specifically, for example, the request reception function 501 deletes all the construction materials (components) created in the construction process.

Thereafter, the request reception function 501 transmits initialization result information (e.g., normal or abnormal) indicating a result of the process executed in S1107 to the construction execution server 105 (S1104). Accordingly, the construction process ends (S51105).

As described above, according to the software installation system 100 of the present embodiment, when a designated software fails to be installed, it is determined, based on information on the software that has failed to be installed on the construction target server 106 and the cause of the failure (the unavailable-combination information 301 and the construction process re-executability information 302), whether or not the designated installed software is capable of being installed; if it is determined that the designated installed software is capable of being installed, a predetermined process (e.g., a process relating to the configuration of components and various setting files) associated with the cause is executed to install the designated software on the construction target server 106. Therefore, even when software cannot be installed due to an error or the like occurring in installing the software, it is possible to perform proper installation according to the cause. As a result, for example, even when an error occurs in installing software, the user of the software installation system 100 does not need to perform operations for coping with the error, such as inspection and check of the system, thereby resulting in reduced time required for the software installation and accordingly, making it possible to reduce human and material resources. Thus, according to the software installation system 100 of the present embodiment, it is possible to provide smooth installation of software.

Further, the software installation system 100 according to the present embodiment determines, based on information on the configuration of the software that has failed to be installed (e.g., a link between components), whether or not the designated software is capable of being installed; if it is determined that the designated software is capable of being installed, a process of modifying the configuration of the designated software (e.g., a process of changing the order of editing and linking the components, or a process of changing the link mode of components) is executed. Therefore, when an improper component is included in the components of the installed software or the components need to be modified, the installed software is capable of being installed by modifying them. As a result, even when the installed software has a complicated configuration, the software is capable of being smoothly installed.

In addition, the software installation system 100 according to the present embodiment determines, based on information on a process that was being executed when the software failed to be installed (e.g., an installation process for a case where an error occurred during the installation, or a process for starting the installed software for a case where an error occurred when the installed software was started), whether or not the designated software is capable of being installed; if it is determined that the designated software is capable of being installed, a process of creating predetermined setting information (e.g., user setting information for the installation, network setting information, or a setting file) is executed. Therefore, it is possible to provide smooth installation of installed software along with a proper operating environment according to the configuration of the information processing device (the construction target server 106) on which the software is to be installed and the configuration of the network 102.

Further, when installing the designated software on the information processing device (the construction target server 106), the software installation system 100 of the present embodiment deletes (initializes) the information created when the designated software failed to be installed.

Therefore, it is possible to reduce the possibility that the installation of the installed software fails due to the information created when the software failed to be installed.

It is to be noted that the software installation system 100 according to the present embodiment outputs information indicating whether or not the designated software is capable of being installed (the construction status display screen 720, the construction completion display screen 740, the selected component combination error display screen 760, the construction process error display screen 780, and the like). Therefore, it is possible for the user to confirm whether or not the installation of the installed software is smoothly progressing.

The above description of the embodiment is for facilitating understanding of the present invention, and does not limit the present invention. The present invention can be modified and improved without departing from the spirit thereof, and the present invention includes equivalents thereof.

For example, in the present embodiment, in the software installation system 100, the only information processing device on which an installed software is to be installed is the construction target server 106. However, the software installation system 1 may install an installed software on a different type of information processing device, and may allow the user to select an information processing device on which the installed software is to be installed.

### REFERENCE SIGNS LIST

100 Software installation system,
1041 Installability information storage unit,
105 Construction execution server,
408 Software installation unit,
106 Construction target server

1. A software installation system comprising a processor and a memory for installing software having a predetermined configuration on an information processing device, the software installation system comprising:
an installability information storage unit that stores information on the software that has failed to be installed on the information processing device, and information on a cause of the failure; and
a software installation unit that determines, when a designated software fails to be installed, whether the designated software is capable of being installed based on the stored information on the cause of the failure, and when the designated software is determined to be capable of being installed, executes a predetermined process associated with the cause to install the designated software on the information processing device.

2. The software installation system according to claim 1, wherein
the installability information storage unit stores, as the information on the cause of the failure, information relating to the configuration of the software that has failed to be installed, and
when the software installation unit fails to install the designated software, the software installation unit determines whether the designated software is capable of being installed based on the stored information relating to the configuration of the software, and when the software installation unit determines that the designated software is capable of being installed, the software installation unit executes, as the predetermined process, a process of modifying the configuration of the designated software to install the designated software on the information processing device.

3. The software installation system according to claim 1, wherein
the installability information storage unit stores, as the information on the cause of the failure, information relating to a process that was being executed when the software failed to be installed, and
when the software installation unit fails to install the designated software, the software installation unit determines whether the designated software is capable of being installed based on the stored information relating to the process, and when the software installation unit determines that the designated software is capable of being installed, the software installation unit executes, as the predetermined process, a process of creating predetermined setting information associated with the process that was being executed to install the designated software on the information processing device.

4. The software installation system according to claim 1, wherein
when the software installation unit executes the predetermined process to install the designated software on the information processing device, the software installation unit deletes information created when the designated software failed to be installed.

5. The software installation system according to claim 1, further comprising
an output unit that outputs information indicating whether the designated software is capable of being installed.

6. The software installation system according to claim 1, further comprising
an output unit that outputs information indicating a result of determination as to whether the designated software is capable of being installed,
wherein the installability information storage unit
stores, as the information on the cause of the failure, information relating to the configuration of the software that has failed to be installed, and
stores, as the information on the cause of the failure, information relating to a process that was being executed when the software failed to be installed,
when the software installation unit fails to install the designated software, the software installation unit determines whether the designated software is capable of being installed based on the stored information relating to the configuration of the software, and when the software installation unit determines that the designated software is capable of being installed, the software installation unit executes, as the predetermined process, a process of modifying the configuration of the designated software to install the designated software on the information processing device,
when the software installation unit fails to install the designated software, the software installation unit determines whether the designated software is capable of being installed based on the stored information relating to the process, and when the software installation unit determines that the designated software is capable of being installed, the software installation unit executes, as the predetermined process, a process of creating predetermined setting information associated with the process that was being executed to install the designated software on the information processing device, and
when the software installation unit executes the predetermined process to install the designated software on the information processing device, the software installation unit deletes information created when the designated software failed to be installed.

7. A software installation method for installing software having a predetermined configuration on an information processing device, wherein
an information processing system including a processor and a memory executes:
an installability information storing process of storing information on the software that has failed to be installed on the information processing device, and information on a cause of the failure; and
a software installation process of determining, when a designated software fails to be installed, whether the designated software is capable of being installed based on the stored information on the cause of the failure, and executing, when the designated software is determined to be capable of being installed, a predetermined process associated with the cause to install the designated software on the information processing device.

8. The software installation method according to claim 7, wherein
the installability information storing process includes storing, as the information on the cause of the failure, information relating to the configuration of the software that has failed to be installed, and
the software installation process includes determining, when the designated software fails to be installed, whether the designated software is capable of being installed based on the stored information relating to the configuration of the software, and executing, when the designated software is determined to be capable of being installed, as the predetermined process, a process of modifying the configuration of the designated software to install the designated software on the information processing device.

9. The software installation method according to claim 7, wherein
the installability information storing process includes storing, as the information on the cause of the failure, information relating to a process that was being executed when the software failed to be installed, and
the software installation process includes determining, when the designated software fails to be installed, whether the designated software is capable of being installed based on the stored information relating to the process, and executing, when the designated software is determined to be capable of being installed, as the predetermined process, a process of creating predetermined setting information associated with the process that was being executed to install the designated software on the information processing device.

10. The software installation method according to claim 7, wherein
the software installation process includes deleting, when executing the predetermined process to install the designated software on the information processing device, information created when the designated software failed to be installed.

11. The software installation method according to claim 7, wherein
an output process of outputting information indicating whether the designated software is capable of being installed is executed.

12. A software installation program for installing software having a predetermined configuration on an information processing device, the software installation program causing
an information processing system including a processor and a memory to execute:
an installability information storing process of storing information on the software that has failed to be installed on the information processing device, and information on a cause of the failure; and
a software installation process of determining, when a designated software fails to be installed, whether the designated software is capable of being installed based on the stored information on the cause of the failure, and executing, when the designated software is determined to be capable of being installed, a predetermined process associated with the cause to install the designated software on the information processing device.
